(19) United States
(12) Patent Application Publication
(10) Pub. No.: US 2010/0201099 A1
(43) Pub. Date: Aug. 12, 2010

(54) Pedal Kickstand

(76) Inventor: Chang Sheng TENG, Dongguan City (CN)

Correspondence Address: Jackson Intellectual Property Group PLLC, 106 Starvale Lane, Shipman, VA, 22971, US

(21) Appl. No.: 12/489,543

(22) Filed: Jun. 23, 2009

(30) Foreign Application Priority Data
Feb. 10, 2009 (CN) 200910037127.X

(51) Int. Cl. B62H 1/08

(52) U.S. Cl. 280/294

(57) ABSTRACT

The present invention relates to the technical field of bicycles, particularly relates to a pedal kickstand. The pedal kickstand of the present invention comprises a pedal, and an earth stand capable of being folded mounted to the outer side of the pedal by pin joint; when the earth stand is unfolded outward to stand on the ground, the bicycle can be held upright steadily. The present invention is mounted to a bicycle and the pedal kickstand is connected to the crank of the bicycle; when the earth stand is unfolded outward for a specific angle, the bicycle can be held upright; for the pedal kickstand provided by the present invention directly utilizes the pedal as the kickstand, the potential hazard caused by the conventional kickstand being exposed can be eliminated, and at the same time, it will not cause the weight problem of additionally mounting a kickstand; it is more beautiful as a whole.

### BACKGROUND OF THE INVENTION

1. Field of the Invention

The present invention relates to the technical field of bicycles, particularly relates to a pedal kickstand that has the effect of supporting a bicycle.

2. Description of the Related Art

Bicycles will all be provided with a kickstand for holding the bicycles upright when not being ridden. Conventional bicycle kickstands are all additionally fixed to the bicycles as an individual component. Conventional bicycle kickstands generally comprise two types, single-pillar type and double-pillar type. A single-pillar type kickstand usually is fixed at the position of the chain stay at the side of the rear wheel, and it can also be fixed at the position of the middle section of the frame at the front end of the chain stay; a double-pillar type kickstand mostly is fixed at the position of the middle section of the frame at the front end of the chain stay.

Both a single-pillar type kickstand and a double-pillar type kickstand all have certain disadvantages: for a single-pillar type kickstand, the bicycle is stood by forming a supporting surface via the touchdown points of the front wheel, the rear wheel, and the single-pillar kickstand, so, the single-pillar type kickstand faces the outside of the bicycle body while it is fixed to the bicycle, and while riding the bicycle, people may be injured for colliding with the single-pillar type kickstand; for a double-pillar type kickstand, it is comparatively heavy, so, the whole weight of the bicycle is increased.

For the above mentioned conventional bicycle kickstands have certain disadvantages, the applicant has worked out a better bicycle kickstand, and hereby files a patent application.

### SUMMARY OF THE INVENTION

The object of the present invention is to provide a pedal kickstand aiming at the disadvantages of the conventional art, which has the pedal functional and the kickstand functional at the same time, so as to dispense with additionally mounting an individual bicycle kickstand; it not only can reduce the whole weight of the bicycle, but also can reduce the production cost; it also can keep the whole bicycle beautiful, and can guarantee the application effect of the bicycle.

To achieve the above mentioned object, the present invention adopts the following technical solution.

The pedal kickstand of the present invention comprises a pedal, and an earth stand capable of being folded mounted to the outer side of the pedal by pin joint; when the earth stand is unfolded outward to stand on the ground, the bicycle can be held upright steadily.

The present invention is mounted to a bicycle, and the pedal kickstand is connected to the crank of the bicycle; when the earth stand is unfolded outward for a specific angle, the bicycle can be held upright; for the pedal kickstand provided by the present invention directly utilizes the pedal as the kickstand, the potential hazard caused by the conventional kickstand being exposed can be eliminated, and at the same time, it will not cause the weight problem of additionally mounting a kickstand; it is more beautiful as a whole.

### BRIEF DESCRIPTION OF THE DRAWINGS

FIG. 1 is a side view of the application of an embodiment of the present invention;

FIG. 2 is a stereo schematic diagram of the application of an embodiment of the present invention;

FIG. 3 is a stereo schematic diagram of the embodiment 1 of the present invention;

FIG. 4 is a stereo schematic diagram at another angle of the embodiment 1 of the present invention;

FIG. 5 is an exploded view of the embodiment 1 of the present invention;

FIG. 6 is a sectional view of a part of the embodiment 1 of the present invention;

FIG. 7 is a sectional view of the earth stand and the pedal being folded of the embodiment 1 of the present invention;

FIG. 8 is a sectional view of the earth stand and the pedal being unfolded of the embodiment 1 of the present invention;

FIG. 9 is a lateral sectional view of a part of the embodiment 1, which shows the angle between the earth stand and the pedal that are unfolded;

FIG. 10 is a stereo schematic diagram of the embodiment 2 of the present invention;

FIG. 11 is a stereo schematic diagram at another angle of the embodiment 2 of the present invention;

FIG. 12 is a front view of the embodiment 2 of the present invention; and

FIG. 13 is an exploded view of the embodiment 2 of the present invention.

### DESCRIPTION OF THE PREFERRED EMBODIMENT

Aspects of the present invention are best understood from the following detailed description when read with reference to the accompanying figures.

The following stated are merely preferred embodiments of the present invention, and are not to limit the scope of the invention.

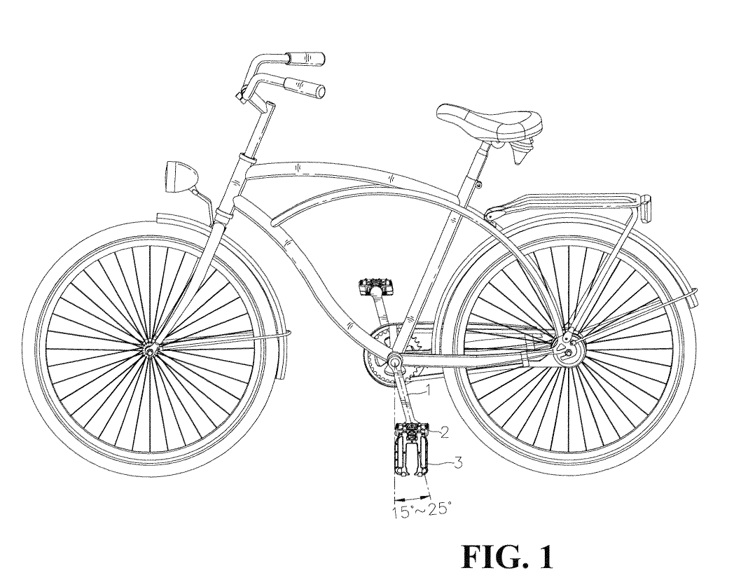

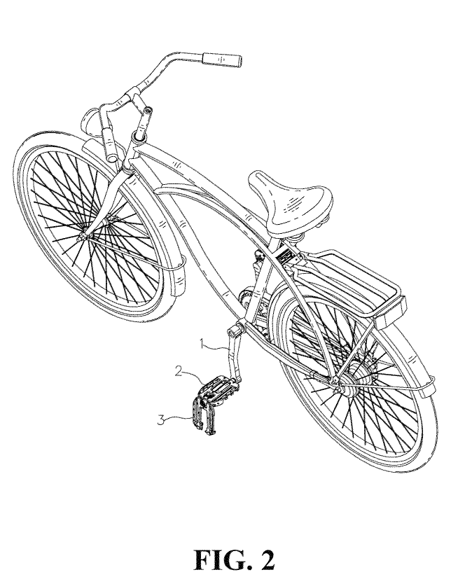

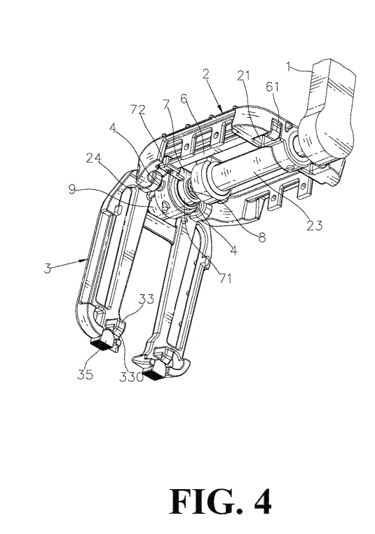

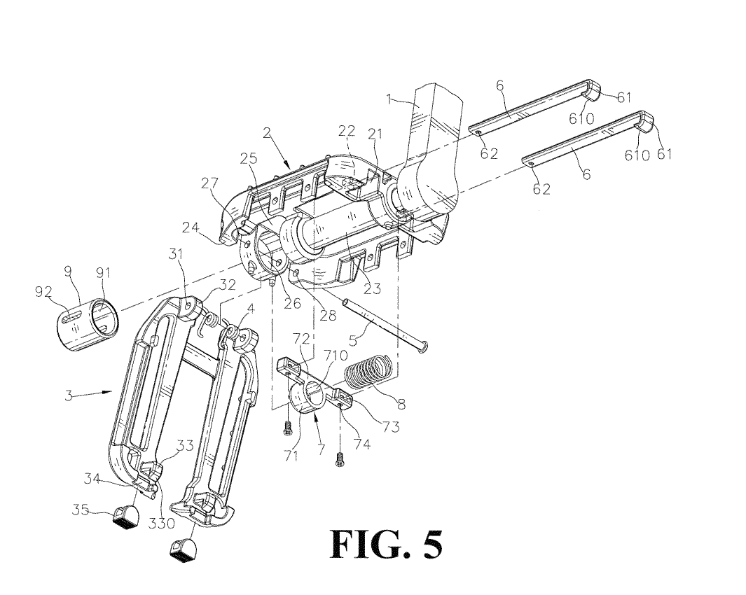

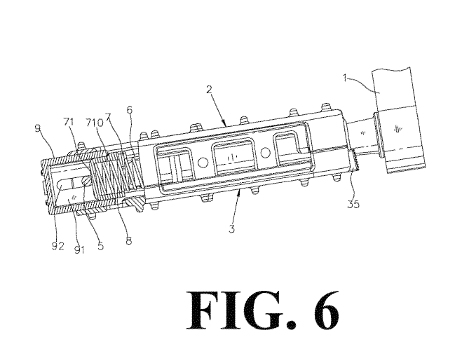

First, referring to FIGS. 1-9, the pedal kickstand of the present invention is mounted to a bicycle. The pedal kickstand of the present invention is connected to the bicycle crank 1 with a proper swing angle. The pedal kickstand can adopt pin joint way, or other connection ways, to be connected to the bicycle crank 1. An earth stand 3 capable of being unfolded and folded is mounted to the outer side of the pedal 2 of the pedal kickstand by pin joint. When the earth stand 3 is unfolded outward to make the angle between the earth stand 3 and the pedal 2 be a specific angle, the bicycle can be held upright.

To further describe the technical solution, characteristics and functions of the present invention, hereinafter the present invention is described with two preferred embodiments and the accompanying figures.

### Embodiment 1

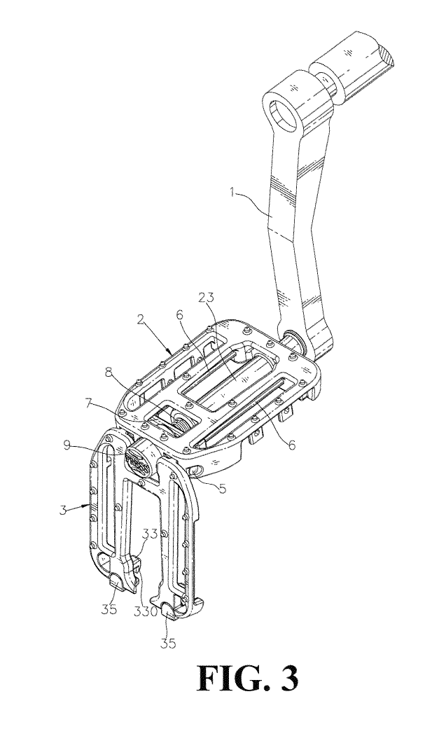

Referring to FIGS. 3-6, mainly an earth stand 3 is mounted to the outer side of the pedal 2 by pin joint; the lower end of the pedal 2 is provided with an axis seat 23, and the axis seat 23 can be connected to the crank 1 by pin joint; an outer pivot terminal edge 24 that is connected to the earth stand 3 by pin joint is at the outside of the pedal 2, and the outer pivot terminal edge 24 is provided with a socket joint hole 26 opposite to the axis seat 23; an interval gap 25 is preliminarily provided between the socket joint hole 26 and the axis seat 23, and the socket joint hole 26 and the axis seat 23 are coaxial.

At least one torsion spring 4 is mounted between the pin joint end of the pedal 2 and the earth stand 3, so as to make the earth stand 3 capable of being unfolded by being twisted elastically, and the earth stand 3 can be folded corresponding to the pedal 2 to be fixed as the form of a pedal with its two surfaces capable of being pedaled. In the present embodiment, the pin joint end of the earth stand 3 is provided with two convex pivot ears 32, and a perforation 31 is provided in the pivot ear 32; besides, two lock pillars 33 that are like barbs facing outward project from the open end of the earth stand 3; the outer end edge of the earth stand 3 is provided with two sunk parts 34, and non-skid pads 35 are separately clamped in the two sunk parts 34; the non-skid pads 35 can prevent the earth stand 3 from sliding, so as to increase the stability of holding a bicycle upright when it is not ridden; the pedal 2 is provided two sunk containing slots 21, and the two sunk containing slots 21 are corresponding to the lock pillars 33 of the earth stand 3; the outer end of the sunk containing slot 21 is the open side; furthermore, the inner edge wall of the opposite side that is opposite to the open side of the sunk containing slots 21 is separately provided with an axial direction perforation 22; slide fastening bars 6 are inserted in the axial direction perforations 22, and the axial direction perforations 22 are used for the slide fastening bars 6 to pass through and slide.

A hook end 61 is provided at the outer end of the slide fastening bar 6, and the inner end of the slide fastening bar 6 is provided with a lockhole 62 that is vertical to the bar body; the slide fastening bar 6 can be connected to a supporting block component 7 via the lockhole 62.

The supporting block component 7 is located in the interval gap 25 that is preliminarily provided by the axis seat 23 and the outer pivot terminal edge 24 of the pedal 2, and the supporting block component 7 is provided with a supporting seat 71 having an inward socket joint opening 710, and a transverse connecting bar 72. The transverse connecting bar 72 is located over the supporting seat 71, and it can deflect towards one side of the socket joint opening 710 of the supporting seat 71. The two ends of the transverse connecting bar 72 are provided with slots 73 for the slide fastening bars 6 to be inserted into, and the slots 73 are provided with locking holes 74. The slide fastening bars 6 can be connected to the supporting block component 7 by locking screws in the locking holes 74 and the lockholes 62 of the slide fastening bars 6.

Besides, the socket joint opening 710 of the supporting seat 71 can be used to mount a compression spring 8; the other end of the compression spring 8 just presses against the outer end side of the axis seat 23 of the pedal 2, so as to make the supporting block component 7 in the interval gap 25 capable of being connected to the two slide fastening bars 6, so, the compression spring 8 provides an elastic force pressing outward even at the ordinary state; furthermore, a press button 9 is mounted outside the supporting seat 71 of the supporting block component 7 by socket joint, and by the press button 9 being mounted in the socket joint hole 26 by socket joint, the supporting block component 7 is mounted on the outer pivot terminal edge 24 of the pedal 2 by socket joint; the two sides of the socket joint hole 26 are provided with sunk pin joint slots 27 for the two pivot ears 32 of the earth stand 3 to be mounted into; the outer pivot terminal edge 24 of the pedal 2 is provided with pivot holes 28, and the pivot holes 28 are through the outer pivot terminal edge 24 and the socket joint hole 26 for a pivot 5 to pass through, so as to connect the earth stand 3 by pin joint; two torsion springs 4 pressing against the pedal 2 and the earth stand 3 are separately located on the pivot 5 between the opposite inner sides of the two pivot ears 32 of the earth stand 3; the torsion springs 4 are located in the pin joint slots 27, and by the action of the two torsion springs 4, the pedal 2 and the earth stand 3 have the elastic force pressing outward at the ordinary state.

The press button 9 that is mounted outside the supporting seat 71 of the supporting block component 7 by socket joint, exactly passes through the socket joint hole 26 located at the outer pivot terminal edge 24, and the press button 9 is a tube cover body with its socket joint opening 91 facing inward; the axial two side bodies of the press button 9 are provided with long gutter holes 92 that pass through the radial direction of the press button 9; the pivot 5 passes through the two long gutter holes 92, so, by the pivot 5 passing through, the press button 9 can be mounted in the socket joint hole 26 of the outer pivot terminal edge 24, and at the same time, the press button 9 can do a moderate retractable displacement via the long gutter holes 92.

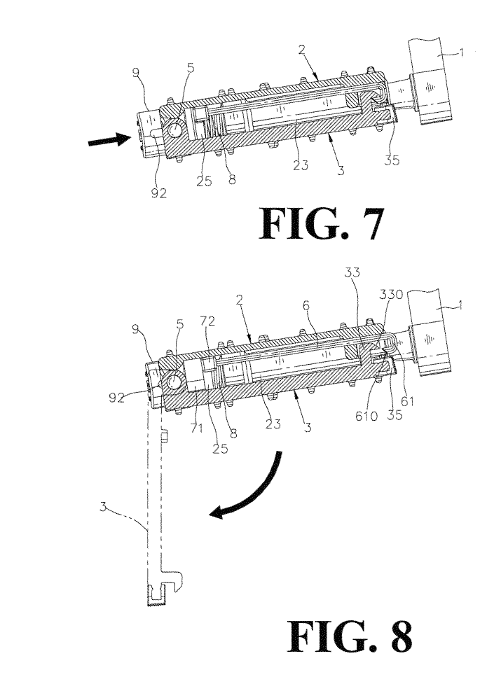

Referring to FIGS. 7-9, by assembling the above mentioned components, when the earth stand 3 and the pedal 2 are folded, they can be fixed via the two hook ends 61 of the slide fastening bars 6 on the pedal 2 and the lock pillars 33 of the earth stand 3 being locked to each other.

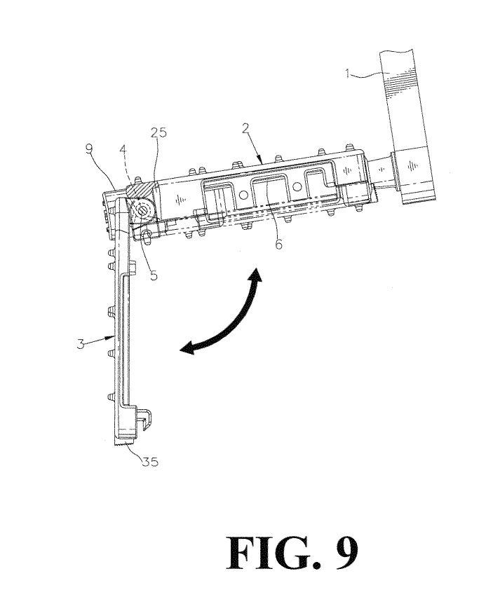

When a user want to hold a bicycle upright, as long as the press button 9 located at the outer pivot terminal edge 24 of the pedal 2 is kicked once, the press button 9 can push the supporting block component 7 to move inward, and at the same time the two slide fastening bars 6 are pushed together to move inward; so, the hook ends 61 of the two slide fastening bars 6 are separated from the lock pillars 33 of the earth stand 3, and then by the action of the torsion springs 4 at the pin joint end of the pedal 2 and the earth stand 3, the earth stand 3 will automatically spring outward; referring to FIG. 9, the earth stand 3 and the pedal 2 can exactly form an unfolded state with the angle between them being over 90 degrees; then the crank 1 is swung backward for a proper angle, so, the bicycle can be held upright by the earth stand 3 of the pedal 2 being stood on the ground; concretely speaking, when the bicycle is held upright on a level ground referring to FIG. 1, the crank 1 is swung backward preferably for about 15-25 degrees; of course, the swing angle can be adjusted according to the inclination angle of the ground.

Furthermore, the hook ends 61 of the two slide fastening bars 6 slideably mounted to the pedal 2 and the lock pillars 33 of the earth stand 3 are separately provided with opposite oblique supporting edges 610, 330; when the earth stand 3 is folded, the lock pillars 33 can exactly act on the oblique supporting edges 610 of the hook ends 61 of the two slide fastening bars 6 via the oblique supporting edges 330 to push the two slide fastening bars 6 to move; for the supporting block component 7 connected to the inner ends of the two slide fastening bars 6 is provided with a compressed compression spring 8, the lock pillars 33 of the earth stand 3 and the hook ends 61 of the two slide fastening bars 6 are capable of being locked and unlocked elastically, so as to form a pedal with its two both surfaces capable of being pedaled.

### Embodiment 2

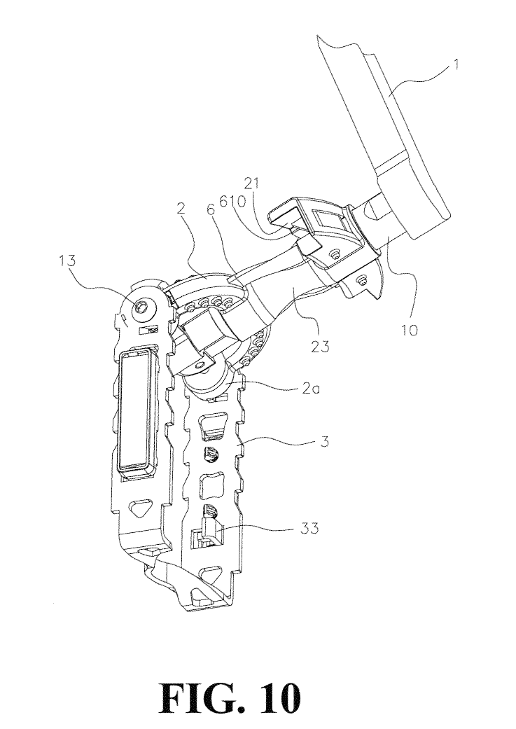

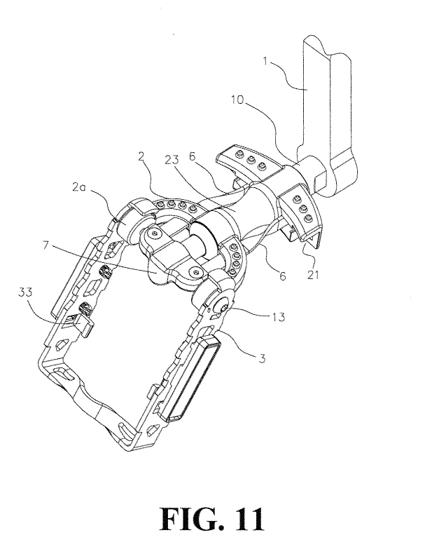

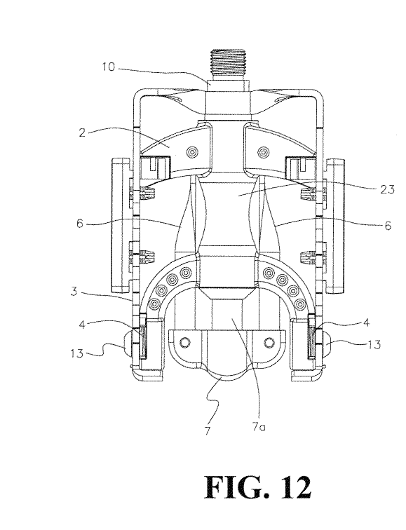

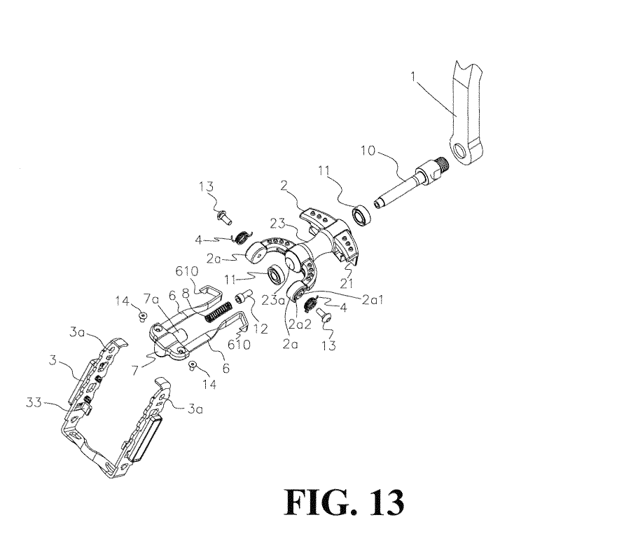

Referring to FIGS. 10-13, mainly an earth stand 3 is mounted to the outer side of the pedal 2 by pin joint; the pedal 2 is provided with an axis seat 23, and the axis seat 23 is provided with a through hole 23a; a slide bar 10 is inserted from one side of the through hole 23a, and the slide bar 10 is connected to two bearings 11 by socket joint; the end of the slide bar 10 that is inserted into the through hole 23a is provided with a locking bolt 12, and the locking bolt 12 limits the bearing 11 to slide off from one side of the slide bar 10; the outer extension end of the slide bar 10 is connected to the bicycle crank 1, and the pedal 2 is capable of rotating around the slide bar 10.

The pin joint end of the pedal 2 is provided with pivot ears 2a, and the pivot ear 2a is provided with a perforation 2a1; the pivot ear 2a is provided with a ring groove 2a2 for containing a torsion spring 4; the pin joint end of the earth stand 3 is provided with pivot holes 3a, and the two side frames of the earth stand 3 are separately connected to the two pivot ears 2a of the pedal 2 by pin joint; wherein, bolts 13 pass through the pivot holes 3a to mount the earth stand 3 to the pivot ears 2a, and the two side frames of the earth stand 3 can separately rotate around the bolts 13.

Lock pillars 33 separately project from the inner walls of the two side frames of the earth stand 3, so as to be locked to the pedal 2, and the lock pillars 33 are L-shaped.

The pedal 2 is provided with sunk containing slots 21, and the sunk containing slots 21 are corresponding to the lock pillars 33 of the earth stand 3; the outer end of the sunk containing slot 21 is the open side, and the inner edge wall of the opposite side that is opposite to the open side of the sunk containing slots 21 is provided with an axial direction perforation 22; a slide fastening bars 6 is inserted in the axial direction perforation 22; the outer ends of the slide fastening bar 6 are provided with hook ends 61, and the inner ends of the slide fastening bar 6 are mounted to a supporting block component 7 via bolts 14; the side of the supporting block component 7 that faces the axis seat 23 is provided with a convex guide pole 7a, and the guide pole 7a is inserted from one side of the through hole 23a of the axis seat 23; a compression spring 8 is located between the guide pole 7a and the slide bar 10.

The hook ends 61 of the slide fastening bar 6 are provided with oblique supporting edges 610 opposite to the lock pillars 33.

The present invention has the following advantages:

1. for the present invention directly utilizes the pedal as the kickstand, the potential hazard caused by the conventional kickstand being exposed can be eliminated;

2. for the present invention directly utilizes the pedal as the kickstand, the whole weight of the bicycle can be reduced greatly;

3. for the present invention directly utilizes the pedal as the kickstand, it has very good aesthetic property and practicability.

Although the present invention has been described in detail with above said preferred embodiments, but it is not to limit the scope of the invention. So, all the modifications and changes according to the characteristic and spirit of the present invention, are involved in the protected scope of the invention.

What is claimed is:

1. A pedal kickstand comprising a pedal, and an earth stand capable of being folded mounted to the outer side of the pedal by pin joint; when the earth stand being unfolded outward to stand on the ground, the bicycle being held upright steadily.

2. The pedal kickstand of claim 1, wherein at least one torsion spring is mounted between the pin joint end of the pedal and the earth stand.

3. The pedal kickstand of claim 1, wherein when the earth stand and the pedal are folded to be fixed, a pedal with its two surfaces capable of being pedaled is formed.

4. The pedal kickstand of claim 1, wherein the outer end edge of the earth stand is provided with non-skid pads.

5. The pedal kickstand of claim 1, wherein the pin joint end of the earth stand is provided with pivot ears, and the pivot ears are connected to the pedal by pin joint; lock pillars project from the open end of the earth stand, so as to be locked to the pedal.

6. The pedal kickstand of claim 5, wherein the pin joint end of the earth stand is provided with convex pivot ears, and the pivot ear is provided with a perforation; the lock pillars at the open end of the earth stand are like barbs facing outward.

7. The pedal kickstand of claim 6, wherein the lock pillar is provided with an oblique supporting edge.

8. The pedal kickstand of claim 5, wherein the pedal is provided with sunk containing slots, and the sunk containing slots are corresponding to the lock pillars of the earth stand; the outer end of the sunk containing slot is the open side, and the inner edge wall of the opposite side that is opposite to the open side of the sunk containing slot is provided with an axial direction perforation; a slide fastening bars is inserted in the axial direction perforation; the outer ends of the slide fastening bars are provided with hook ends, and the inner ends of the slide fastening bars are mounted to a supporting block component; an axis seat is located below the pedal, and a compression spring is located between the supporting block component and the outer end side of the pedal axis seat to press against them.

9. The pedal kickstand of claim 8, wherein the hook ends of the slide fastening bars are provided with oblique supporting edges opposite to the lock pillars of the earth stand.

10. The pedal kickstand of claim 8, wherein an outer pivot terminal edge that is connected to the earth stand by pin joint is at the outside of the pedal, and the outer pivot terminal edge is provided with a socket joint hole opposite to the axis seat; an interval gap is preliminarily provided between the socket joint hole and the axis seat, and the socket joint hole and the axis seat are coaxial; the supporting block component is located in the interval gap, and the supporting block component is provided with a supporting seat having an inward socket joint opening, and a transverse connecting bar; the two ends of the transverse connecting bar are provided with slots for the slide fastening bars to be inserted into, and locking holes for fixing the slide fastening bars.

11. The pedal kickstand of claim 10, wherein a press button is mounted outside the supporting seat of the supporting block component by socket joint, and the press button is mounted in the socket joint hole of the pedal by socket joint; the two sides of the socket joint hole are provided with sunk pin joint slots for the pivot ears of the earth stand to be mounted into; the outer pivot terminal edge is provided with a pivot hole, and the pivot hole is through the socket joint hole for a pivot to pass through, so as to connect the earth stand by pin joint; torsion springs pressing against the pedal and the earth stand are located on the pivot between the pin joint slots.

12. The pedal kickstand of claim 10, wherein a press button is mounted outside the supporting seat of the supporting block component by socket joint, and the press button is mounted in the socket joint hole of the pedal by socket joint; the press button is a tube cover body with its socket joint opening facing inward, and the side body of the press button is provided with axial long gutter holes that pass through the radial direction of the press button.

13. The pedal kickstand of claim 1, wherein the pin joint end of the pedal is provided with pivot ears, and the pivot ear is provided with a perforation; the pivot ear is provided with a ring groove for containing a torsion spring; the pin joint end of the earth stand is provided with pivot holes, and the two side frames of the earth stand are separately connected to the two pivot ears of the pedal by pin joint; bolts pass through the pivot holes to mount the earth stand to the pivot ears, and the two side frames of the earth stand can separately rotate around the bolts.

14. The pedal kickstand of claim 1, wherein lock pillars separately project from the inner walls of the two side frames of the earth stand, so as to be locked to the pedal 2, and the lock pillars are L-shaped.

15. The pedal kickstand of claim 1, wherein the pedal is connected to the crank of the bicycle, and when the bicycle is held upright, the crank is swung backward for about 15-25 degrees.

16. The pedal kickstand of claim 15, wherein at least one torsion spring is mounted between the pin joint end of the pedal and the earth stand.

17. The pedal kickstand of claim 15, wherein when the earth stand and the pedal are folded to be fixed, a pedal with its two surfaces capable of being pedaled is formed.

18. The pedal kickstand of claim 15, wherein the outer end edge of the earth stand is provided with non-skid pads.

19. The pedal kickstand of claim 15, wherein the pin joint end of the earth stand is provided with pivot ears, and the pivot ears are connected to the pedal by pin joint; lock pillars project from the open end of the earth stand, so as to be locked to the pedal.

20. The pedal kickstand of claim 19, wherein the pin joint end of the earth stand is provided with convex pivot ears, and the pivot ear is provided with a perforation; the lock pillars at the open end of the earth stand are like barbs facing outward.

21. The pedal kickstand of claim 20, wherein the lock pillar is provided with an oblique supporting edge.

22. The pedal kickstand of claim 19, wherein the pedal is provided with sunk containing slots, and the sunk containing slots are corresponding to the lock pillars of the earth stand; the outer end of the sunk containing slot is the open side, and the inner edge wall of the opposite side that is opposite to the open side of the sunk containing slot is provided with an axial direction perforation; a slide fastening bars is inserted in the axial direction perforation; the outer ends of the slide fastening bars are provided with hook ends, and the inner ends of the slide fastening bars are mounted to a supporting block component; an axis seat is located below the pedal, and a compression spring is located between the supporting block component and the outer end side of the pedal axis seat to press against them.

23. The pedal kickstand of claim 22, wherein the hook ends of the slide fastening bars are provided with oblique supporting edges opposite to the lock pillars of the earth stand.

24. The pedal kickstand of claim 22, wherein an outer pivot terminal edge that is connected to the earth stand by pin joint is at the outside of the pedal, and the outer pivot terminal edge is provided with a socket joint hole opposite to the axis seat; an interval gap is preliminarily provided between the socket joint hole and the axis seat, and the socket joint hole and the axis seat are coaxial; the supporting block component is located in the interval gap, and the supporting block component is provided with a supporting seat having an inward socket joint opening, and a transverse connecting bar; the two ends of the transverse connecting bar are provided with slots for the slide fastening bars to be inserted into, and locking holes for fixing the slide fastening bars.

25. The pedal kickstand of claim 24, wherein a press button is mounted outside the supporting seat of the supporting block component by socket joint, and the press button is mounted in the socket joint hole of the pedal by socket joint; the two sides of the socket joint hole are provided with sunk pin joint slots for the pivot ears of the earth stand to be mounted into; the outer pivot terminal edge is provided with a pivot hole, and the pivot hole is through the socket joint hole for a pivot to pass through, so as to connect the earth stand by pin joint; torsion springs pressing against the pedal and the earth stand are located on the pivot between the pin joint slots.

26. The pedal kickstand of claim 24, wherein a press button is mounted outside the supporting seat of the supporting block component by socket joint, and the press button is mounted in the socket joint hole of the pedal by socket joint; the press button is a tube cover body with its socket joint opening facing inward, and the side body of the press button is provided with axial long gutter holes that pass through the radial direction of the press button.

27. The pedal kickstand of claim 2, wherein the pin joint end of the pedal is provided with pivot ears, and the pivot ear is provided with a perforation; the pivot ear is provided with a ring groove for containing a torsion spring; the pin joint end of the earth stand is provided with pivot holes, and the two side frames of the earth stand are separately connected to the two pivot ears of the pedal by pin joint; bolts pass through the pivot holes to mount the earth stand to the pivot ears, and the two side frames of the earth stand can separately rotate around the bolts.

28. The pedal kickstand of claim 2, wherein lock pillars separately project from the inner walls of the two side frames of the earth stand, so as to be locked to the pedal 2, and the lock pillars are L-shaped.

29. The pedal kickstand of claim 15, wherein the pedal is provided with an axis seat, and the axis seat is provided with a through hole; a slide bar is inserted from one side of the through hole, and the outer extension end of the slide bar is connected to the bicycle crank; the pedal is capable of rotating around the slide bar.

30. The pedal kickstand of claim 29, wherein the slide bar is connected to two bearings by socket joint; the end of the slide bar that is inserted into the through hole is provided with a locking bolt, and the locking bolt limits the bearing to slide off from one side of the slide bar.

31. The pedal kickstand of claim 29, wherein the pedal is provided with sunk containing slots, and the sunk containing slots are corresponding to the lock pillars of the earth stand; the outer end of the sunk containing slot is the open side, and the inner edge wall of the opposite side that is opposite to the open side of the sunk containing slot is provided with an axial direction perforation; a slide fastening bar is inserted in the axial direction perforation; the outer ends of the slide fastening bars are provided with hook ends, and the inner ends of the slide fastening bars are mounted to a supporting block component; the side of the supporting block component that faces the axis seat is provided with a convex guide pole, and the guide pole is inserted from one side of the through hole of the axis seat; a compression spring is located between the guide pole and the slide bar.

32. The pedal kickstand of claim 31, wherein the hook ends of the slide fastening bars are provided with oblique supporting edges opposite to the lock pillars.

33. The pedal kickstand of claim 31, wherein the slide fastening bars are mounted to the supporting block component via bolts.
